(19) United States
(12) Patent Application Publication
(10) Pub. No.: US 2015/0026640 A1
(43) Pub. Date: Jan. 22, 2015

(54) Information Searching Method and Terminal

(71) Applicant: Huawei Device Co., Ltd., Shenzhen (CN)

(72) Inventors: Konggang Wei, Shenzhen (CN); Haibo Shan, Shenzhen (CN); Wenhao Chen, Shenzhen (CN)

(21) Appl. No.: 14/462,629

(22) Filed: Aug. 19, 2014

Related U.S. Application Data
(63) Continuation of application No. PCT/CN2012/076813, filed on Jun. 13, 2012.

(30) Foreign Application Priority Data
Feb. 29, 2012 (CN) 201210050096.3

(51) Int. Cl. G06F 3/0482; G06F 3/0484; G06F 3/0488; G06F 3/0483

(52) U.S. Cl. CPC G06F 3/0482; G06F 3/0483; G06F 3/04842; G06F 3/0488
USPC 715/823; 715/835

(57) ABSTRACT

An information searching method and a terminal, which are related to the field of communications technologies, address a problem of operation inconvenience in an information searching process. The method includes displaying, after a user triggers a target letter in an alphabetical index area, information summarized by the target letter in an information display area. The alphabetical index area is used to display an alphabetical index and the information display area is used to display information to be searched for. The method also includes receiving a first specified operation triggered by the user and locking the information displayed in the information display area so that, after the information display area receives a page-turning operation triggered by the user, the information displayed in the information display area is switched only within a range of currently displayed information.

### CROSS-REFERENCE TO RELATED APPLICATIONS

This application is a continuation of International Application No. PCT/CN2012/076813, filed on Jun. 13, 2012, which claims priority to Chinese Patent Application No. 201210050096.3, filed on Feb. 29, 2012, both of which are hereby incorporated by reference in their entireties.

### TECHNICAL FIELD

The present disclosure relates to the field of communications technologies, and in particular, to an information searching method and a terminal.

### BACKGROUND

With continuous development of communications technologies, a terminal is becoming increasingly powerful and may store more and more information such as contact information or file information. An increase in the amount of information stored in the terminal may cause considerable inconvenience when searching for particular information. Searching for contact information stored in a terminal is used as an example. There are various manners of searching for a contact in a terminal having an address book. The following is a commonly-used and user-friendly searching manner.

As shown in FIG. 1, the middle and left areas of a screen 102 of a terminal 100 are a contact information display area 104, and the right area is an alphabetical index area 106. When a finger stays on a target letter in the alphabetical index area, the system searches for one or more contacts in the address book that have the target letter as an initial. The system then displays information corresponding to the contact or contacts in the contact information display area. The finger may move away from the target letter and a target contact can be searched for in the contact information display area.

In a process of implementing the foregoing contact searching, the inventor finds that at least the following problem exists in the prior art. When a target contact is selected in a contact information display area, if a finger touches another letter in an alphabetical index area by accident, a target letter needs to be reselected in the alphabetical index area, which brings much inconvenience for the operation.

### SUMMARY

Embodiments of the present disclosure provide an information searching method and a terminal addressing a problem of inconvenience in an information searching process.

To achieve the foregoing objective, the following technical solutions are adopted in the embodiments of the present disclosure. An information searching method including displaying, after a user triggers a target letter in an alphabetical index area, information summarized by the target letter in an information display area. The alphabetical index area is used to display index letters and the information display area is used to display information to be searched for. The method also includes receiving a first specified operation triggered by the user and locking the information displayed in the information display area so that, after the information display area receives a page-turning operation triggered by the user, the information displayed in the information display area is switched only within the range of currently displayed information. In another embodiment, a terminal is provided. The terminal includes a first displaying unit configured to, after a user triggers a target letter in an alphabetical index area, display information summarized by the target letter in an information display area. The alphabetical index area is used to display index letters and the information display area is used to display information to be searched for. The terminal also includes a locking unit configured to receive a first specified operation triggered by the user and lock the information displayed in the information display area so that, after the information display area receives a page-turning operation triggered by the user, the information displayed in the information display area is switched only within the range of currently displayed information.

With the technical solutions provided in the embodiments of the present disclosure information displayed in an information display area can be locked after a user selects a target letter. With the display area temporarily locked, the target letter in an alphabetical index area need not be reselected if a user's finger accidentally touches another index letter when the user selects target information in the information display area.

### BRIEF DESCRIPTION OF DRAWINGS

To describe the technical solutions in the embodiments of the present disclosure or in the prior art more clearly, the following briefly introduces the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a schematic diagram of a display interface of a terminal;

FIG. 2 is a flowchart of an information searching method according to an embodiment of the present disclosure;

FIG. 3 is a flowchart of another information searching method according to an embodiment of the present disclosure;

FIG. 4 is a structural diagram of a terminal according to an embodiment of the present disclosure; and

FIG. 5 is a structural diagram of another terminal according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An information searching method in accordance with some embodiments is shown in FIG. 2. The method includes the following steps.

201. After a user triggers a target letter in an alphabetical index area, display information summarized by the target letter in an information display area.

When the user needs to search for information, the user may first find, in the alphabetical index area, a target letter corresponding to target information. The user triggers the target letter, and the information summarized by the target letter is displayed piece by piece in the information display area. The alphabetical index area is used to display index letters and the information display area is used to display information to be searched for.

The information summarized by the target letter, according to different information to be searched for and different searching policies, may be information whose initial is the target letter, may be information whose filename contains the target letter, and may be information whose file contains the target letter. This embodiment of the present disclosure does not limit the information thereto.

202. Receive a first specified operation triggered by the user and lock the information displayed in the information display area so that, after the information display area receives a page-turning operation triggered by the user, the information displayed in the information display area is switched only within the range of currently displayed information.

When the user only needs to search within the range of the information summarized by the target letter, the user may trigger the first specified operation so as to temporarily lock the content displayed in the information display area so that the information displayed in the information display area is only limited to the information summarized by the target letter. This makes it convenient for the user to search for the target information.

According to the information searching method provided in this embodiment, after a user triggers a target letter in an alphabetical index area, information summarized by the target letter is displayed in an information display area. After a first specified operation triggered by the user is received, the information displayed in the information display area is locked so that, after the information display area receives a page-turning operation triggered by the user, the information displayed in the information display area is switched only within the range of currently displayed information. This avoids having to reselect the target letter in the alphabetical index area if a user's finger accidentally touches another index letter when the user selects target information in the information display area.

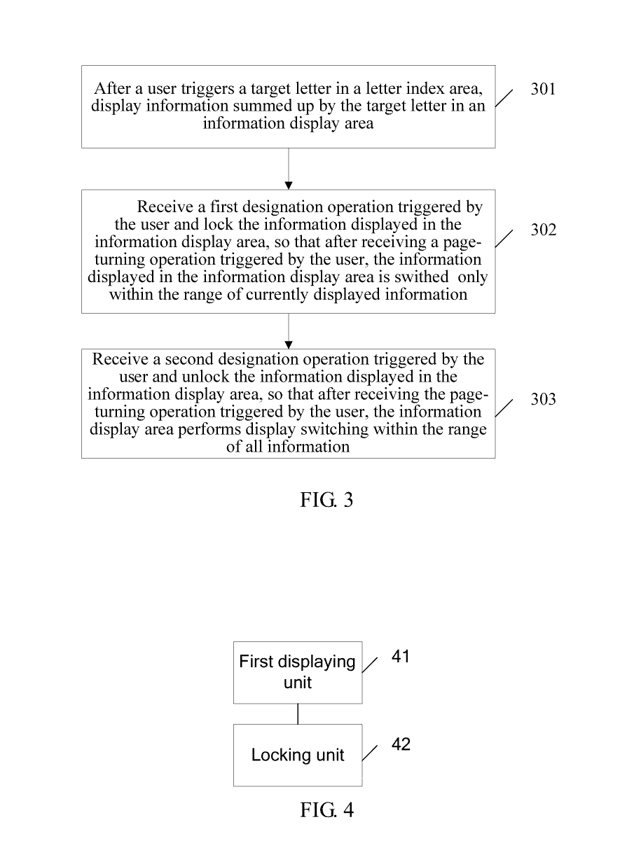

An information searching method in accordance with some embodiments is shown in FIG. 3. The method includes the following steps.

301. After a user triggers a target letter in an alphabetical index area, display information summarized by the target letter in an information display area.

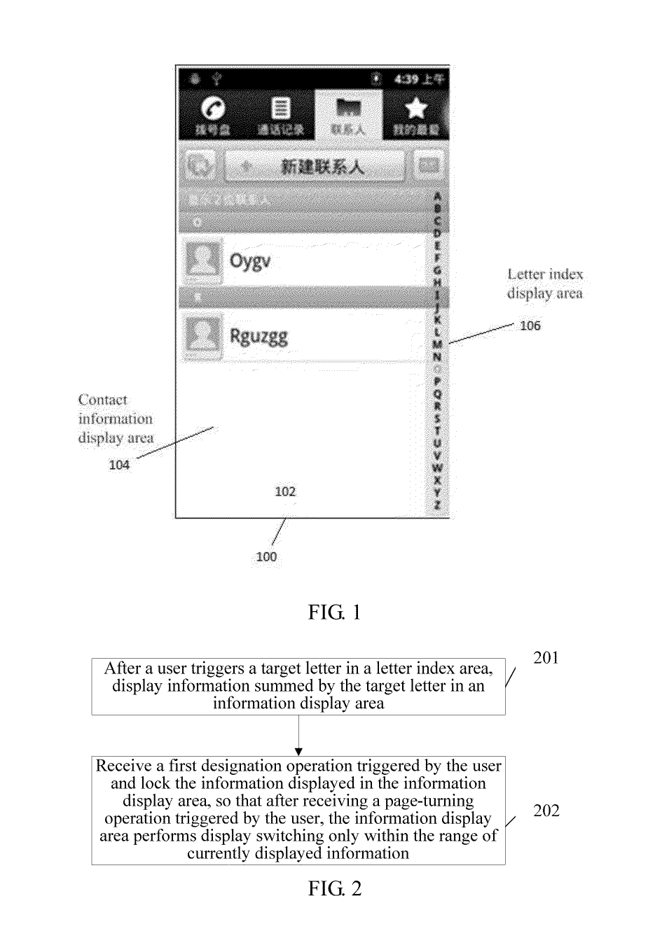

Searching for contact information in a mobile phone, such as a mobile phone using an Android operating system, is used as an example for description in this embodiment. As shown in FIG. 1, when searching for a contact, a mobile phone interface includes an alphabetical index area 106 and a contact information display area 104. The information summarized by the target letter in this embodiment may refer to information about a contact whose initial is the target letter.

When the user needs to search for a contact, the user may first find an initial of a target contact, that is, the target letter in the alphabetical index area. The user then triggers the target letter. Optionally, when the user triggers the target letter in the alphabetical index area, the target letter is zoomed in at the same time in the contact information display area. In some embodiments, information about a contact whose initial is the target letter is displayed in the contact information display area after the user triggers the target letter in the alphabetical index area. The alphabetical index area is used to display index letters and the contact information display area is used to display information about a contact to be searched for.

302. Receive a first specified operation triggered by the user and lock the information displayed in the information display area so that, after the information display area receives a page-turning operation triggered by the user, the information displayed in the information display area is switched only within the range of currently displayed information.

When the user only needs to search contacts who have the target letter as an initial, the user may trigger the first specified operation to lock the content displayed in the contact information display area of a mobile phone screen so that the contact information displayed in the contact information display area is limited to the information about the contacts who have the target letter as the initial. This makes it convenient for the user to search for the target contact and reduce repetitive operations caused by a mis-operation. Even if the mis-operation occurs, the content displayed in the contact information display area is switched only within the information about the contacts who have the target letter as the initial.

The first specified operation may be, for example, double tapping the target letter. The first specified operation may also be touching and holding the target letter. That is, when triggering the target letter in the alphabetical index area, the user double taps the target letter, touches and holds the target letter, or touches and holds the target letter while double tapping the target letter. Optionally, if the target letter is zoomed in at the same time in the contact information display area when the user triggers the target letter in the alphabetical index area, the first specified operation may also be double tapping the target letter zoomed in and touching and holding the target letter zoomed in.

303. Receive a second specified operation triggered by the user and unlock the information displayed in the information display area so that, after the information display area receives the page-turning operation triggered by the user, the information displayed in the information display area is switched within the range of all information.

If the user wants to unlock the information and expand a search scope, the user may perform the second specified operation. The mobile phone receives the second specified operation triggered by the user and unlocks the content displayed in the contact information display area so that, after the contact information display area receives the page-turning operation triggered by the user, the contact information displayed in the information display area is switched within the range of all information.

The second specified operation may be double tapping the alphabetical index area or any blank area and touching and holding the alphabetical index area or any blank area.

According to the information searching method provided in this embodiment, after a user triggers a target letter in an alphabetical index area, information summarized by the target letter is displayed in an information display area, a first specified operation triggered by the user is received, and the information displayed in the information display area is locked. As such, after the information display area receives a page-turning operation triggered by the user, the information displayed in the information display area is switched only within the range of currently displayed information. This avoids having to reselect the target letter in the alphabetical index area if a user's finger accidentally touches another index letter when the user selects target information in the information display area.

The terminal disclosed herein in not limited to a particular type of terminal. For example, the terminal may be a mobile terminal such as a mobile phone and a computer tablet.

In an embodiment, the terminal includes a first displaying unit 41 and a locking unit 42 as shown in FIG. 4.

The first displaying unit 41 is configured to, after a user triggers a target letter in an alphabetical index area, display information summarized by the target letter in an information display area. The alphabetical index area is used to display index letters and the information display area is used to display information to be searched for.

The locking unit 42 is configured to receive a first specified operation triggered by the user and lock the information displayed in the information display area so that, after the information display area receives a page-turning operation triggered by the user, the information displayed in the information display area is switched only within the range of currently displayed information.

According to the terminal provided in this embodiment, after a user triggers a target letter in an alphabetical index area, a first displaying unit displays information summarized by the target letter in an information display area. A locking unit receives a first specified operation triggered by the user and locks information displayed in the information display area so that, after the information display area receives a page-turning operation triggered by the user, the information displayed in the information display area is switched only within the range of currently displayed information. This avoids having to reselect the target letter in the alphabetical index area if a user's finger accidentally touches another index letter when the user selects target information in the information display area.

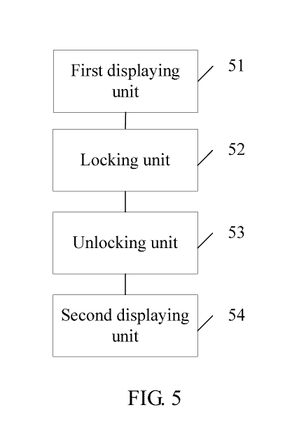

A terminal in accordance with some embodiments is shown in FIG. 5. The terminal includes a first displaying unit 51, a locking unit 52, and an unlocking unit 53.

The first displaying unit 51 is configured to, after a user triggers a target letter in an alphabetical index area, display information summarized by the target letter in an information display area. The alphabetical index area is used to display index letters of information and the information display area is used to display information to be searched for.

The locking unit 52 is configured to receive a first specified operation triggered by the user and lock the information displayed in the information display area so that, after the information display area receives a page-turning operation triggered by the user, the information displayed in the information display area is switched only within the range of currently displayed information.

In some embodiments, the first specified operation received by the locking unit 52 may include double tapping the target letter and touching and holding the target letter.

The unlocking unit 53 is configured to receive a second specified operation triggered by the user and unlock the information displayed in the information display area so that, after the information display area receives the page-turning operation triggered by the user, the information displayed in the information display area is switched within the range of all information.

In some embodiments, the second specified operation received by the unlocking unit 53 may include double tapping the alphabetical index area or any blank area and touching and holding the alphabetical index area or any blank area.

Optionally, the terminal may further include a second displaying unit 54 configured to zoom in the target letter in the information display area when the user triggers the target letter in the alphabetical index area.

If the second displaying unit 54 is contained, the first specified operation received by the locking unit may include tapping the target letter zoomed in, double tapping the target letter zoomed in, and touching and holding the target letter zoomed in.

According to the terminal provided in this embodiment, after a user triggers a target letter in an alphabetical index area, a displaying unit displays information summarized by the target letter in an information display area. A locking unit receives a first specified operation triggered by the user and locks the information displayed in the information display area so that, after the information display area receives a page-turning operation triggered by the user, the information displayed in the information display area is switched only within the range of currently displayed information. This avoids having to reselect the target letter in the alphabetical index area if a user's finger accidentally touches another index letter when the user selects target information in the information display area.

Based on the foregoing descriptions of the embodiments, a person skilled in the art may clearly understand that the present disclosure may be implemented by software in addition to necessary universal hardware or by hardware only. In most circumstances, the former is a preferred implementation manner. Based on such an understanding, the technical solutions of the present disclosure essentially or the part contributing to the prior art may be implemented in a form of a software product. The software product is stored in a readable storage medium, such as a floppy disk, a hard disk, or an optical disc of a computer, and includes several instructions for instructing a computer device (which may be a personal computer, a server, a network device, or the like) to perform the methods described in the embodiments of the present disclosure.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An information searching method, comprising:
displaying, after a user triggers a target letter in an alphabetical index area, information summarized by the target letter in an information display area, wherein the alphabetical index area is used to display index letters, and wherein the information display area is used to display information to be searched for; and
receiving a first specified operation triggered by the user and locking the information displayed in the information display area so that, after the information display area receives a page-turning operation triggered by the user, the information displayed in the information display area is switched only within a range of currently displayed information.

2. The information searching method according to claim 1, wherein the first specified operation comprises at least one of double tapping the target letter and touching and holding the target letter.

3. The information searching method according to claim 1, wherein when the user triggers the target letter in the alphabetical index area, the method further comprises zooming in the target letter in the information display area, wherein the first specified operation comprises at least one of tapping the target letter zoomed in, double tapping the target letter zoomed in, and touching and holding the target letter zoomed in.

4. The information searching method according to claim 2, wherein when the user triggers the target letter in the alphabetical index area, the method further comprises zooming in the target letter in the information display area, wherein the first specified operation comprises at least one of the following operations: tapping the target letter zoomed in, double tapping the target letter zoomed in, and touching and holding the target letter zoomed in.

5. The information searching method according to claim 1, wherein the method further comprises receiving a second specified operation triggered by the user and unlocking the information displayed in the information display area so that, after the information display area receives the page-turning operation triggered by the user, the information displayed in the information display area is switched within a range of all information.

6. The information searching method according to claim 2, wherein the method further comprises receiving a second specified operation triggered by the user and unlocking the information displayed in the information display area so that, after the information display area receives the page-turning operation triggered by the user, the information displayed in the information display area is switched within a range of all information.

7. The information searching method according to claim 3, wherein the method further comprises receiving a second specified operation triggered by the user and unlocking the information displayed in the information display area so that, after the information display area receives the page-turning operation triggered by the user, the information displayed in the information display area is switched within a range of all information.

8. The information searching method according to claim 4, wherein a second specified operation comprises at least one of double tapping the alphabetical index area or any blank area and touching and holding the alphabetical index area or any blank area.

9. A terminal, comprising:
a first displaying unit configured to, after a user triggers a target letter in an alphabetical index area, display information summarized by the target letter in an information display area, wherein the alphabetical index area is used to display index letters and the information display area is used to display information to be searched for; and
a locking unit configured to receive a first specified operation triggered by the user and lock the information displayed in the information display area so that, after the information display area receives a page-turning operation triggered by the user, the information displayed in the information display area is switched only within a range of currently displayed information.

10. The terminal according to claim 9, wherein the first specified operation received by the locking unit comprises at least one of double tapping the target letter and touching and holding the target letter.

11. The terminal according to claim 9, wherein the terminal further comprises a second displaying unit configured to zoom in the target letter in the information display area when the user triggers the target letter in the alphabetical index area, wherein, for a terminal containing the second displaying unit, the first specified operation received by the locking unit comprises at least one of tapping the target letter zoomed in, double tapping the target letter zoomed in, and touching and holding the target letter zoomed in.

12. The terminal according to claim 10, wherein the terminal further comprises a second displaying unit configured to zoom in the target letter in the information display area when the user triggers the target letter in the alphabetical index area, wherein, for a terminal containing the second displaying unit, the first specified operation received by the locking unit comprises at least one of tapping the target letter zoomed in, double tapping the target letter zoomed in, and touching and holding the target letter zoomed in.

13. The terminal according to claim 9, wherein the terminal further comprises an unlocking unit configured to receive a second specified operation triggered by the user and unlock the information displayed in the information display area so that, after the information display area receives the page-turning operation triggered by the user, the information displayed in the information display area is switched within a range of all information.

14. The terminal according to claim 10, wherein the terminal further comprises an unlocking unit configured to receive a second specified operation triggered by the user and unlock the information displayed in the information display area so that, after the information display area receives the page-turning operation triggered by the user, the information displayed in the information display area is switched within a range of all information.

15. The terminal according to claim 11, wherein the terminal further comprises an unlocking unit configured to receive a second specified operation triggered by the user and unlock the information displayed in the information display area so that, after the information display area receives the page-turning operation triggered by the user, the information displayed in the information display area is switched within a range of all information.

16. The terminal according to claim 13, wherein the second specified operation received by the unlocking unit comprises at least one of double tapping the alphabetical index area or any blank area and touching and holding the alphabetical index area or any blank area.
